(19) United States
(12) Patent Application Publication
(10) Pub. No.: US 2006/0229963 A1
(43) Pub. Date: Oct. 12, 2006

(54) Portfolio performance tracking

(76) Inventors: Jennifer Creager, San Diego, CA (US); Bradley T. Creager, San Diego, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/104,049

(22) Filed: Apr. 11, 2005

(51) Int. Cl. G06Q 40/00

(52) U.S. Cl. 705/35

(57) ABSTRACT

Portfolio performance tracking and reporting includes integration of performance tracking information for previously-sold securities with performance tracking information for securities that are still held in the portfolio. Performance tracking for securities that are still held is performed by comparing the security's current value with the purchase price (basis). Performance tracking for securities that have been sold is performed by comparing the sale price with the purchase price; changes to value that took place subsequent to the sale date are ignored, as they have no bearing on the performance analysis for the portfolio. A report is generated including performance tracking information for individual securities and/or for the portfolio as a whole.

### FIELD OF THE INVENTION

The present invention relates generally to portfolio performance tracking tools, and more particularly to techniques for combining performance tracking information for securities that are still held with performance tracking information for securities that have been sold.

### BACKGROUND OF THE INVENTION

Many software packages and websites now offer portfolio performance tracking functionality. The portfolio performance features typically allow an investor to enter information about his or her portfolio, including quantities of various securities, original purchase prices, commissions, and the like. In some cases, this information can be automatically extracted based on stored historical transaction information of the investor. Current value can be manually entered or it can be automatically obtained from online sources. A report is then generated, showing, for various securities in the investor's portfolio, a comparison between original purchase price and the current value of the security holdings. The report can show overall gain/loss, return on investment, and/or other useful values and statistics. Graphics, such as charts, can be generated. In many cases, the user can customize the reports so as to control the type of information shown and the overall layout of the reports.

One example of a website offering such functionality is quote.yahoo.com. Referring now to FIG. 5, there is shown an example of a portfolio performance tracking report 500 generated by this quote.yahoo.com. For each security in the portfolio, information is shown, such as: symbol, current value, change in value from yesterday, volume, quantity held, original purchase price, original total value, and overall gain/loss (both as absolute value and return on investment percentage). Totals for the portfolio are also shown, including overall gain/loss amounts for the portfolio.

One limitation of such a report is that it does not accurately integrate performance tracking information for previously-sold securities with performance tracking information for securities that are still held. Typically, once a security has been sold, the gain/loss from the security no longer appears on the portfolio performance tracking report, and is no longer reflected in the overall totals for the portfolio. If the investor chooses to leave the security in the online portfolio in an attempt to continue to include the security in future reports, the resulting tracking information will be misleading since it will reflect current values rather than values at the time of sale. In addition, such an approach can lead to additional confusion since it fails to distinguish, in the online portfolio, between securities that are still held and those that have been sold. In situations where a portion of the holdings of a security are sold and the remainder held, additional confusion and inaccuracies can be introduced.

What is needed is a method, system, and computer program product for accurately integrating performance tracking information for previously-sold securities with performance tracking information for securities that are still held. What is further needed is a method, system, and computer program product for generating portfolio performance tracking reports that correctly reflect values for securities that have already been sold. What is further needed is a method, system, and computer program product for generating such reports that clearly indicate gain/loss and return on investment for securities that have been sold as well as for securities that are still held.

### SUMMARY OF THE INVENTION

The present invention facilitates accurate analysis and tracking of portfolio performance, including integrating performance tracking information for previously-sold securities with performance tracking information for securities that are still held. Performance tracking for securities that are still held is performed by comparing the security's current value with the purchase price (basis). Performance tracking for securities that have been sold is performed by comparing the sale price with the purchase price; changes to value that took place subsequent to the sale date are ignored, as they have no bearing on the performance analysis for the portfolio. Performance tracking for securities that have been partially sold (in other words some portion of the holdings have been sold and another portion is still held) is performed by determining performance for the sold portion (as described above), determining performance for the still-held portion (as described above), and combining the two results.

In one aspect, the present invention freezes the price of a security as of a sale date. The performance of the security is determined as a function of the purchase price, sale price, and period of time for which it was held (so that an annual rate of return can be calculated). If desired, lot size, commissions, fees, and other factors may also be considered. If desired, the proceeds from the sale of the security are also frozen (stored) so that they can be easily used for future calculations of portfolio performance. For securities that are still held, the performance is determined as a function of the purchase price, current value, and period of time for which it was held (so that an annual rate of return can be calculated). Again, if desired, lot size, commissions, fees, and other factors may also be considered.

In one aspect, the present invention combines the above types of performance analyses to derive an overall performance metric for the portfolio as a whole, including both currently-held securities and those that have been sold. The user need not manually track past gains and losses, and he or she need not manually combine such values with current portfolio performance metrics. Rather, the present invention provides an automatic performance assessment that takes into account both currently held and sold securities.

### BRIEF DESCRIPTION OF THE DRAWINGS

The accompanying drawings illustrate several embodiments of the invention and, together with the description, serve to explain the principles of the invention.

FIG. 1 is a block diagram depicting a functional architecture for implementing the invention according to one embodiment.

FIG. 2 is a block diagram depicting a functional architecture for implementing the invention according to another embodiment.

FIG. 3 is a flowchart depicting a method for implementing the present invention according to one embodiment.

FIG. 4 is an example of a report generated by a system according to one embodiment of the present invention.

FIG. 5 is an example of a prior art portfolio report.

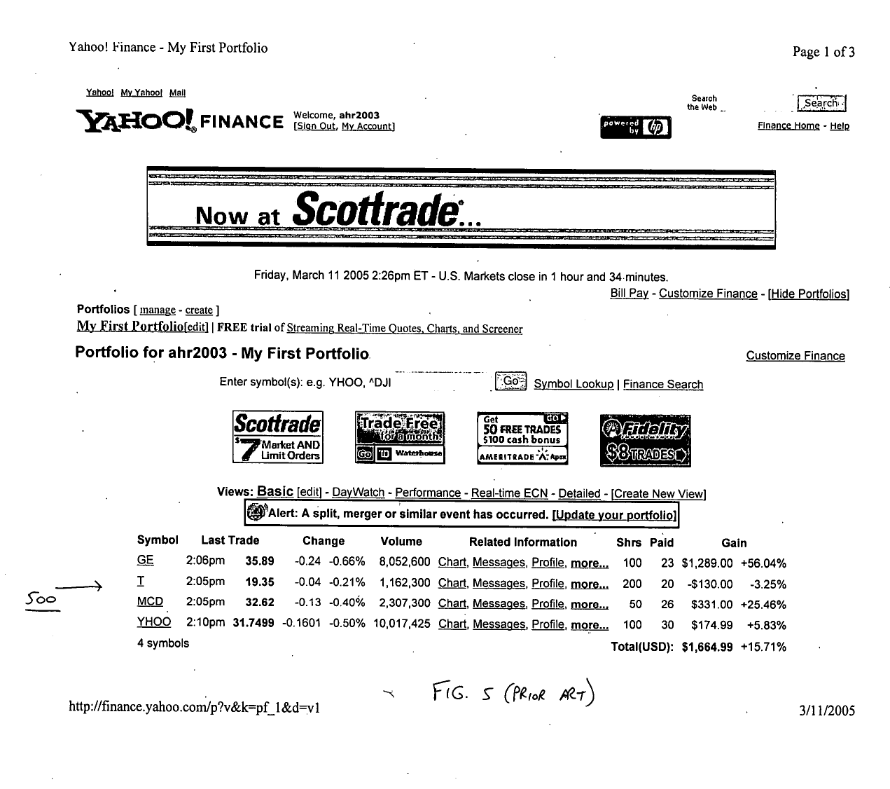

One skilled in the art will recognize that these Figures are merely examples of the operation of the invention according to one embodiment, and that other user interface arrangements and modes of operation can be used without departing from the essential characteristics of the invention.

### DETAILED DESCRIPTION OF THE EMBODIMENTS

The present invention is now described more fully with reference to the accompanying Figures, in which several embodiments of the invention are shown. The present invention may be embodied in many different forms and should not be construed as limited to the embodiments set forth herein. Rather these embodiments are provided so that this disclosure will be complete and will fully convey the invention to those skilled in the art.

For illustrative purposes, the invention is described in connection with generating reports for tracking the performance of a portfolio of securities. Various specific details are set forth herein and in the Figures, to aid in understanding the present invention. However, such specific details are intended to be illustrative, and are not intended to restrict in any way the scope of the present invention as claimed herein. In particular, one skilled in the art will recognize that the invention can be used in connection with assets of any type, and is not limited to securities. In addition, the particular screen layouts, appearance, and terminology as depicted and described herein, are intended to be illustrative and exemplary, and in no way limit the scope of the invention as claimed.

In one embodiment, the present invention is implemented in a conventional personal computer system running an operating system such as Microsoft Windows XP, available from Microsoft Corporation of Redmond, Wash. The invention may be embodied in software that runs on the personal computer. The invention may be included as add-on software, or it may be a feature of an application that is bundled with the computer system or sold separately, or it may be implemented in a website or web-based portfolio tracking tool. In one embodiment, the invention can be implemented in a spreadsheet application such as Microsoft Excel, or a database program such as Microsoft Access. Data can be entered manually by the investor, or it can be automatically extracted from online sources and/or locally stored databases. One skilled in the art will recognize that the present invention can be implemented in various configurations wherein data for generating portfolio reports are collected from any combination of local, server-based, and/or remote sources. For example, portfolio holdings might be stored locally at the user's computer, and current security values retrieved from online sources. Alternatively, portfolio holdings might be stored at a server and retrieved by the user's computer as needed. In addition, the report generation functionality of the present invention can be located at the user's machine or at a remote server; if located remotely, the invention can be implemented as a web-based application which runs in response to a client machine's request, and which transmits completed reports (for example via HTTP) to the client machine for display/output to the user.

Output generated by the invention can be displayed on a screen, transmitted to a remote device, stored in a database or other storage mechanism, or used in any other way. Output generated by the invention can be used to trigger transactions automatically, and/or to generate alerts. In addition, in some embodiments, the invention makes use of input provided to the computer system via input devices such as a keyboard, mouse, touchpad, or the like. Such hardware components, including their operation and interactions with one another and with a central processing unit of the personal computer, are well known in the art of computer systems and therefore are not depicted here. In other embodiments, the invention makes use of previously stored or derived information concerning the status of a stock portfolio.

Functional Architecture

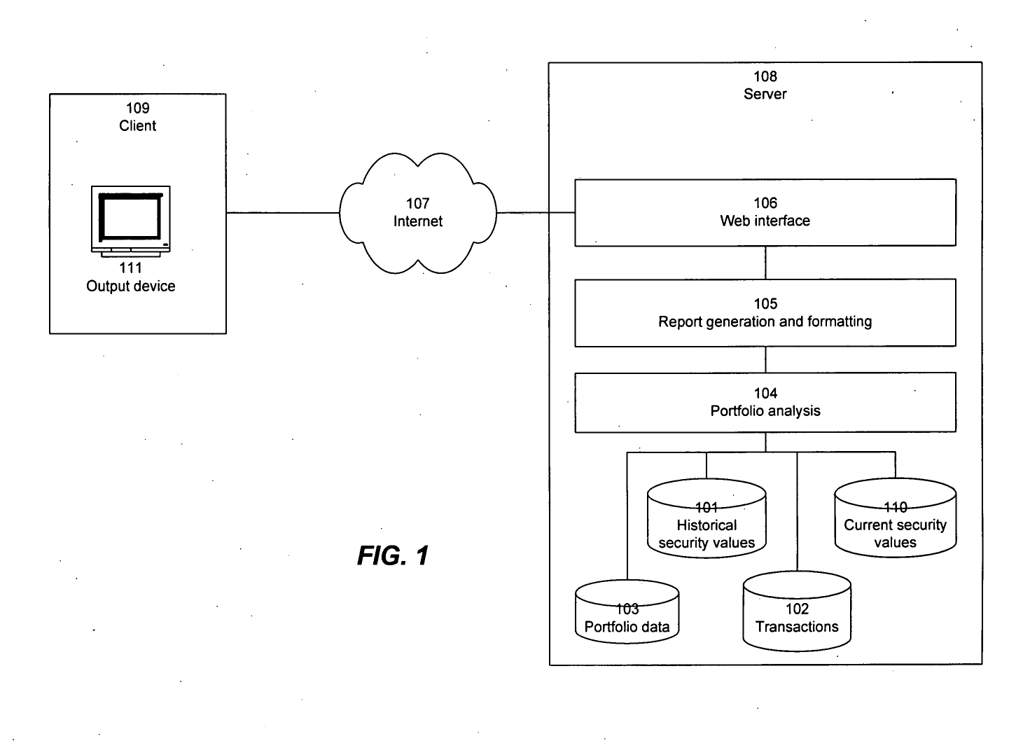

Referring now to FIG. 1, there is shown a block diagram depicting a functional architecture for implementing the invention according to one embodiment. In one embodiment, the invention is implemented as software running at server 108. Client 109 accesses the functionality of server 108 software via a network such as the Internet 107. For example, a user can activate a browser application at client 109 and navigate to a website for accessing his or her stock portfolio. After providing some sort of authentication indicia (via entry of a login identifier, password, and/or the like), the user is able to access portfolio data stored at server 108 and to specify the type of report desired. Portfolio performance is determined and presented to the user according to the steps set forth below, which provide improved performance tracking by taking into account securities that are currently held as well as those that have previously been sold.

In one embodiment, server 108 includes the following components, as shown in FIG. 1. One skilled in the art will recognize that the functional modules and data stores shown in FIG. 1 are merely exemplary, and that the functionality of the present invention can be implemented using other combinations of modules and data stores. Furthermore, one skilled in the art will recognize that any or all of the functional modules and data stores of FIG. 1 can be located locally or remotely with respect to server 108 and/or with one another, or that they can be combined or split further into other configurations, all without departing from the essential characteristics of the present invention as claimed herein.

Portfolio data store 103 stores information describing users' portfolios, including quantities of securities held, date purchased, price paid, commission, and the like. As is known in the art, such information is stored, for example, in a database comprising a number of records. Each record specifies the information for a particular security holding for a particular user. Preferably, data store 103 is stored in a secure manner to reduce the possibility of a hacker gaining access to sensitive data.

Historical security values data store 101 stores information describing historical prices for securities. For example, data store 101 may include a daily close price for each of a (large) number of securities, so that the particular close price of a security on a particular date can be easily retrieved for use in a report. As is known in the art, such information is stored, for example, in a database comprising a number of records; each record specifies the close price for a security as of a particular date.

Transactions data store 102 stores information describing users' transactions with respect to their securities. For example, data store 102 stores, for each buy, sell, or other transaction, information such as the price paid, commission, date of transaction, and the like. As is known in the art, such information is stored, for example, in a database comprising a number of records. Each record specifies the information for a particular transaction for a particular security for a particular user. Preferably, data store 103 is stored in a secure manner to reduce the possibility of a hacker gaining access to sensitive data.

Current security values 110 can be a data store, or it can be an interface to a data source providing market quotes for securities. In one embodiment, such information is retrieved on an as-needed basis when portfolio analysis module 104 needs the information to generate a report or perform other analysis. In another embodiment, current security values 110 are stored and updated periodically, so as to provide quicker access to such data when it is needed.

Portfolio analysis module 104 performs the steps described below to generate performance metrics for portfolios. In one embodiment, module 104 is implemented as a software application running within a web-based application framework. Module 104 retrieves information from data stores 101, 102, 103, and 110 as needed to generate performance metrics as described below. For example, module 104 retrieves portfolio data from data store 103 to determines which securities are in a particular user's portfolio; then module 104 obtains transaction data from data store 102 to determine what buys and sells took place for those securities, and at what prices; then module 104 obtains historical security values from data store 101, and current security values from data store (or data source) 110, in order to generate portfolio performance metrics as described below.

Report generation and formatting module 105 generates reports using information provided by portfolio analysis module 104. Reports generated by module 105, as described in more detail below, include overall portfolio performance tracking information that combines performance of securities that are currently held with performance of securities that were previously held but have been sold. In one embodiment, module 105 formats its reports according to user-specified preferences.

Web interface 106 transmits reports generated by module 105 across the Internet 107 to client 109 for display on output device 111. The principles behind such transmission of data across a network are well known in the art. For example, if the invention is implemented as a web-based application, web interface 106 provides a mechanism for HTTP transmission of data to client 109.

Other functional architectures are also possible. For example, some or all of the functional components can be located at client 109 rather than at server 108; in fact, the invention can be implemented without any server-side components, in other words as a purely local, stand-alone software application.

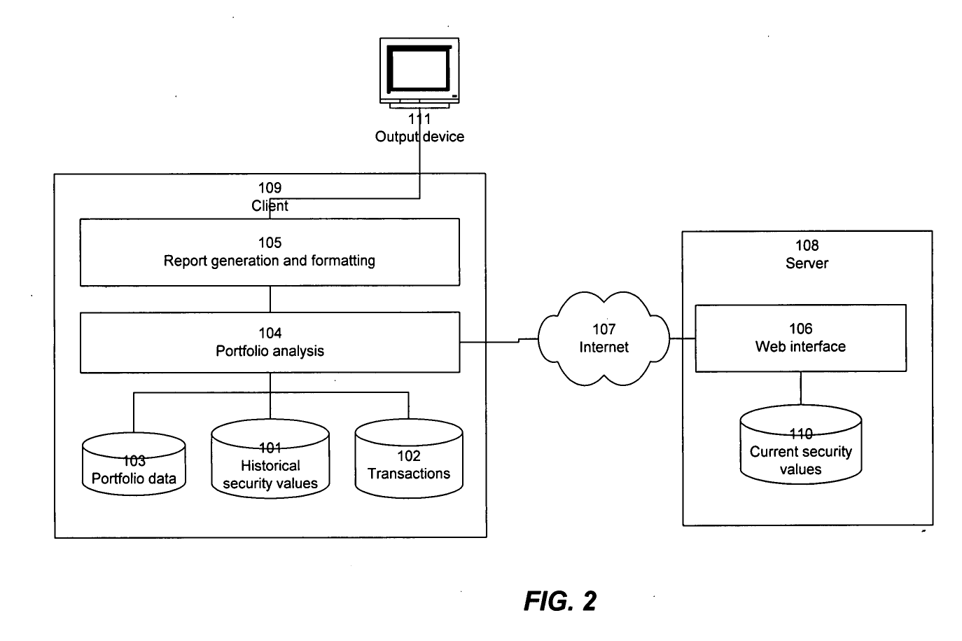

Referring now to FIG. 2, there is shown an alternative embodiment wherein most of the functionality for generating reports, and most of the portfolio data, are located at client 109, and wherein client 109 contacts server 108 just to obtain current security values from data store 110.

Thus, portfolio data store 103, historical security values data store 101, and transaction data store 102, are stored locally at client 109. Portfolio analysis module 104 and report generation and formatting module 105 are software components running at client 109. Module 104 obtains current security values, for example by communication with server 108 via the Internet 107; in response, server 108 retrieves current security values from data store 110 and provides them to analysis module 104. Alternatively, current security values can be obtained from any other source, for example via manual entry by the user.

Module 105 generates a report that is output on device 111, which may be a screen, printer, or the like.

One skilled in the art will recognize that any other configuration of the various components is possible, with some components being located at client 109 and some (or none) at server 108.

Method

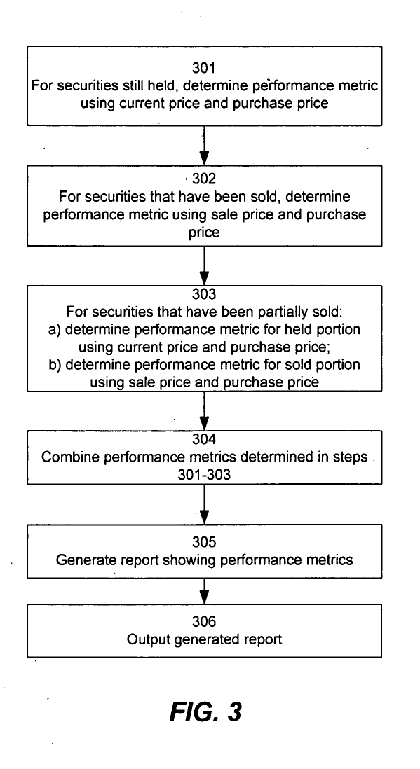

The following method can be implemented regardless of the particular functional architecture that is used for implementing the present invention. In one embodiment, the method of the present invention generates a report that provides accurate performance metrics for a portfolio, and that takes into account securities that are currently held as well as securities that were in the portfolio but have been sold. Referring now to FIG. 3, there is shown a flowchart of a method for generating such performance metrics according to one embodiment of the present invention.

The particular steps shown in FIG. 3 are merely illustrative of the technique of the present invention. One skilled in the art will recognize that the steps need not be performed in any particular order, and that in some embodiments (for example if the invention is implemented in a spreadsheet application), they may be performed concurrently with one another. Furthermore, not all steps may be applicable to all situations; for example, if all securities in a portfolio have been sold, then there may not be a need to determine performance metrics for securities still held; conversely, if no securities in a portfolio have been sold, then there may not be a need to determine performance metrics for securities that have been sold.

For illustrative purposes, FIG. 3 depicts determination of performance metrics for securities in two steps 301, 302. In step 301, performance metrics for securities that are still held are determined by comparing the current price (value) of each security with the purchase price. In one embodiment, the current value is obtained from data store 110, and purchase price is obtained from transactions data store 102 or from portfolio data 103 combined with historical values 101. In one embodiment, the performance metric for a still-held security is the rate of return for the security. This is determined by calculating the difference between current value and purchase price; this difference can be expressed as a percentage of the purchase price, and then divided by the time period for which the security has been held to determine an annualized rate of return (or a rate of return according to some other period).

In one embodiment, the size of the position (in other words, the amount of stock held) is also considered, so as to determine a dollar value return figure.

As an example of step 301, consider a stock that was purchased for $50/share three months ago, and which now has a value of $55/share. The rate of return is (55−50)/50=10%. The annualized rate of return is 10%/( 3/12), or 40%. If, for example, the size of the holding is 100 shares, the return can also be expressed in dollar figures as +$500 ($5 per share over the three-month period of time). (In this and all other examples, commissions and fees are ignored; although one skilled in the art will recognize that commissions and fees can be used to adjust the performance metrics accordingly).

In step 302, performance metrics for securities that have been sold are determined by comparing the sale price (value) of each security with the purchase price. In one embodiment, the sale price and purchase price are obtained from transactions data store 102 or from portfolio data 103 combined with historical values 101. In one embodiment, the performance metric for the previously-sold security is the rate of return for the security over the time period it was held. This is determined by calculating the difference between sale price and purchase price; this difference can be expressed as a percentage of the purchase price, and then divided by the time period for which the security was held to determine an annualized rate of return (or a rate of return according to some other period).

In one embodiment, the size of the position (in other words, the amount of stock that was held and sold) is also considered, so as to determine a dollar value return figure.

As an example of step 302, consider a stock that was purchased for $130/share on Jan. 15, 2003, and which was sold for $180/share on Jun. 15, 2004 (17 months later). The rate of return is (180−130)/130=38.5%. The annualized rate of return is 38.5%/( 17/12), or 27.2%. If, for example, the size of the holding is 100 shares, the return can also be expressed in dollar figures as +$5000 ($50 per share over the 17-month period of time).

In step 303, performance metrics for securities that have been partially sold are determined. In one embodiment, the performance metric is determined by a) for that portion of the security holding that is still held, determining the rate of return as described above in step 301; and b) for that portion of the security holding that has been sold, determining the rate of return as described above in step 302.

As an example of step 303, consider a stock that was purchased for $18/share on Mar. 3, 2004. 100 shares were purchased. Three months later, 25 shares were sold at a price of $20/share. The remaining 75 shares are still held, and are valued at $24/share as of Mar. 3, 2005.

For that portion of the holding that is still held (75 shares), the rate of return is (24−18)/18=33.3%, and the annualized rate of return is 33%/( 12/12)=33.3%. For that portion of the holding that was sold, the rate of return is (20−18)/18=11.1%, and the annualized rate of return is 11.1%/( 3/12)=44.4%. (Interestingly, the annualized rate of return is higher for the portion that was sold, even though that portion made only $2 per share as compared to the $6 per share that has been earned by the still-held portion). Based on the sizes of the holdings, the total return for the security can be expressed in dollar figures as +$450 for the still-held portion and +$50 for the previously-sold portion, for a total of +$500.

In step 304, the performance metrics determined in steps 301-303 are combined. One skilled in the art will recognize that there are many different techniques for combining these performance metrics, some of which use absolute dollar gains and losses, some of which use rates of return, and some of which use annualized (or otherwise normalized) rates of return. For illustrative purposes, a number of examples of such combination are discussed herein, without intending to create any implication that the invention is limited to any particular technique of combination.

One method for combining performance metrics is to determine the total change in value for the portfolio and to express that change either in absolute terms, or in terms of a rate of return (based on the initial value), or in terms of an annualized (or normalized) rate of return.

Continuing the example set forth above, consider the following three securities:
Stock A: 100 shares purchased for $50/share three months ago and now having a value of $55/share. Total change in value is +$500. Rate of return is 10%. Annualized rate of return is 40%.
Stock B: 100 shares purchased for $130/share on Jan. 15, 2003, sold for $180/share on Jun. 15, 2004. Total change in value is +$5000. Rate of return is 38.5%. Annualized rate of return is 27.2%
Stock C: 100 shares purchased for $18/share on Mar. 3, 2004. 25 shares sold for $20/share on Jun. 3, 2004. Remaining 75 shares valued at $24/share on Mar. 3, 2005. Total change in value is +$500. Rate of return is 33.3% for the still-held portion and 11.1% for the sold portion. Annualized rate of return is 33.3% for the still-held portion and 44.4% for the sold portion.

Combining the changes in value in absolute terms, the overall change in value for the portfolio is $500+$5000+$500=$6000.

In one embodiment, the rates of return are combined by simply averaging the rates of return for the various securities in the portfolio (including those previously held), to yield AVG (10%, 38.5%, 33.3%, 11.1%)=23.2%. However, such a calculation does not take into account the amount of stock that was subject to each of the individual gain percentages.

Another approach is to use the absolute dollar gain, divided by the starting value for the portfolio. Thus, the rate of return is $6000/(100*$50+100*$130+100*$18)=30.3%.

This rate of return can be annualized (or otherwise normalized). Assuming that the portfolio was created on Jan. 3, 2003 and it is now Mar. 3, 2005, the 30.3% gain has taken place over a 26-month period of time. Thus, the annualized rate of return is 30.3%/( 26/12)=14.0%.

In more complex examples, money may be added to (or removed from) the portfolio as time goes by. Each “lot” of money can thus be considered as a separate sub-portfolio for purposes of determining rate of return. For example, if the user added $1000 to the portfolio on Jan. 3, 2004, then any portfolio performance metric for the first year of the portfolio Jan. 3, 2003 to Jan. 3, 2004) would not be affected. However, any performance metric for Jan. 3, 2004 to the present would take into account the growth (or decay) of the newly added $1000. Thus, for example, if the $1000 were invested in a stock that gained $10 from Jan. 3, 2004 to the present, the overall change in value of the portfolio would increase by $10 to $6010. The rate of return would be 30.3% for the initial portfolio and 1% for the newly added $1000. And the annualized rate of return would be 30.3% for the initial portfolio and 1% for the newly added $1000. A combined annualized rate of return can be calculated based on a combination of the rates of return taking into account starting values for the portions of the portfolio: ($6000*30.3%+$1000*1%)/$7000=26.1%. Thus, the relatively poor performance of the newly added $1000 (as compared to the original $6000) has brought down the overall average annualized rate of return for the portfolio.

In another embodiment, overall portfolio performance is measured with respect to an entire pool of money in the portfolio, and with respect to the amount of time the money has been available. Thus, if the user starts with $5000 on a certain date, then the performance of the portfolio is measured by determining the overall value of the portfolio and tracking the rate of return based on an initial investment of $5,000. Regardless of buys, sells, and held cash, the overall rate of return then becomes a function of the overall portfolio value, measured as an increase/decrease from the start amount.

In such an embodiment, if the portfolio holder withdraws funds, or adds funds, appropriate adjustments are made so that the rate of return for a particular time period is always determined with reference to the baseline amount for that time period.

For example, if the user starts with $5000 on Jan. 1, 1998, then adds $1000 on Jan. 1, 2000, then withdraws $2000 on Jan. 1, 2003, the portfolio performance is determined by combining:
Rate of return for the original $5000 from 1998 to 2000;
Rate of return based on $6000 (or based on current total portfolio value as of Jan. 1, 2000), from 2000 to 2003;
Rate of return based on $4000 (or based on current total portfolio value as of Jan. 1, 2003), from 2003 to present.

In one embodiment, the present invention also allows a user to “freeze” the performance at a certain time (e.g. end of year), and start over at a new year; so you can track performance year by year

Regardless of which methodology is used in step 304 to combine performance metrics, the next step is to generate 305 a report showing the performance metrics. This report can take any form and be displayed or printed according to any desired mechanism. In one embodiment, the report shows individual performance metrics, such as rates of returns, for the various securities in the portfolio (including previously-held securities). In another embodiment, the report shows the combined performance metric determined in step 304. In yet another embodiment, the report shows some combination of the individual and combined metrics. In some embodiments, the user can specify certain characteristics of the report, including the type of information displayed and the format for the display. For example, the user can specify that only certain securities be included, and/or that the report cover a specific time period, and/or other parameters.

In one embodiment, where the report is generated at server 108, it is transmitted to client 109 for example via the Internet 107 using HTTP or other transport mechanisms, and the sent to output device 111 for display to the user. In another embodiment, where the report is generated at client 109, it is sent directly to output device 111 for display to the user. Output device 111, which may be a display, printer, or the like, outputs 306 the generated report. In one embodiment, the user can specify that the report be saved, emailed, or otherwise transmitted if desired.

Sample Report

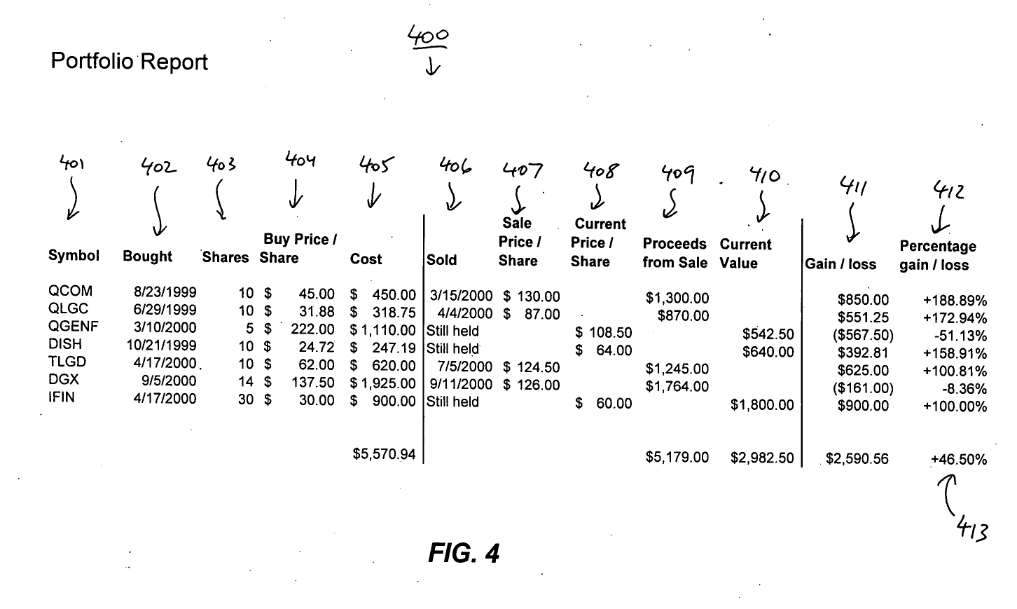

Referring now to FIG. 4, there is shown an example of a report 400 generated by a system according to one embodiment of the present invention. One skilled in the art will recognize that the particular layout and type of date shown in report 400 is merely exemplary, and that many other layouts and formats are possible without departing from the essential characteristics of the present invention.

In the example report 400 of FIG. 4, seven stocks are shown. For each stock, the following information is provided:
Symbol 401: This is the common stock exchange symbol for the security.
Date purchased 402: The date the security was purchased by the portfolio holder.
Shares 403: The number of shares purchased.
Buy price/share 404: The price paid per share at the time of purchase. This can be obtained from locally stored records, or from historical records of stock prices.
Cost 405: The buy price/share 404 multiplied by the number of shares purchased 403, to obtain the total cost 405 of the security. Commissions and fees are not shown in this example; however in one embodiment, commissions and fees can be shown so that they form part of cost 405.
Date sold 406: The date the security was sold. If the security is still held in the portfolio, the notation “Still held” appears. In one embodiment, partially-sold securities can be split into two rows in report 400, one row for the portion that is still held and another row for the portion that has been sold.
Sale price/share 407: For securities that have been sold, this column shows the sale price per share. This can be determined, for example, from locally stored records, or from historical records of stock prices. For securities that are still held, this column is blank.
Current price/share 408: For securities that are still held, this column shows the current price per share. This can be determined, for example, from online sources of current quotes for securities. For securities that have been sold, this column is blank.
Proceeds from sale 409: For securities that have been sold, this column shows the total proceeds from the sale. This can be determined, for example, by multiplying the value in column 407 by the number of shares sold 403. In one embodiment, this value also takes into account sales commissions and/or fees. For securities that are still held, this column is blank.
Current value 410: For securities that are still held, this column shows the total current value. This can be determined, for example, by multiplying the value in column 408 by the number of shares held 403. For securities that have been sold, this column is blank.
Gain/loss 411: For securities that have been sold, this column shows the total gain/loss from the sale, by subtracting cost 405 from proceeds 409. For securities that are still held, this column shows the total unrealized gain/loss for the security, by subtracting cost 405 from current value 410.
Percentage gain/loss 412: For securities that have been sold, this column shows the total percentage gain/loss from the sale, by dividing proceeds 409 by cost 405. For securities that are still held, this column shows the total percentage unrealized gain/loss for the security, by dividing current value 410 by cost 405.

Total rate of return 413 is also shown. In one embodiment, this is determined by dividing the sum of total proceeds 409 and current value 410 by cost 405.

Other formats for report 400 are also possible. For example, in one embodiment a graphical report can be derived, showing overall performance for the portfolio over a period of time. As another example, a graphical report can show comparative performance data for the various securities in a portfolio. One skilled in the art will recognize that many other techniques for displaying such data can be applied, according to well-known mechanisms for graphically depicting financial data.

In the above description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and modules presented herein are not inherently related to any particular computer or other apparatus. Various general-purpose systems may be used with programs in accordance with the teachings herein, or it may prove convenient to construct more specialized apparatuses to perform the method steps. The required structure for a variety of these systems will appear from the description below. In addition, the present invention is not described with reference to any particular programming language. It will be appreciated that a variety of programming languages may be used to implement the teachings of the invention as described herein. Furthermore, as will be apparent to one of ordinary skill in the relevant art, the modules, features, attributes, methodologies, and other aspects of the invention can be implemented as software, hardware, firmware or any combination of the three. Of course, wherever a component of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of skill in the art of computer programming. Additionally, the present invention is in no way limited to implementation in any specific operating system or environment.

It will be understood by those skilled in the relevant art that the above-described implementations are merely exemplary, and many changes can be made without departing from the true spirit and scope of the present invention. Therefore, it is intended by the appended claims to cover all such changes and modifications that come within the true spirit and scope of this invention.

What is claimed is:

1. A computer-implemented method for tracking performance of a portfolio, the method comprising:
for at least a first security that is currently held in the portfolio, determining a first performance metric based on a comparison of a current value of the security with a historical price of the security;
for at least a second security that was previously held in the portfolio and has been sold, determining a second performance metric based on a comparison of a sale price of the security with a historical price of the security;
combining the first and second performance metrics to obtain an overall performance metric for the portfolio; and
outputting the overall performance metric for the portfolio.

2. The method of claim 1, wherein:
the first performance metric comprises a rate of return for the first security, measured from an acquisition date to a current date;
the second performance metric comprises a rate of return for the second security, measured from an acquisition date to a sale date; and
the overall performance metric for the portfolio comprises a rate of return as of the current date.

3. The method of claim 1, wherein:
the first performance metric comprises a rate of return for the first security, measured from an acquisition date to a report date;
the second performance metric comprises a rate of return for the second security, measured from an acquisition date to a sale date; and
the overall performance metric for the portfolio comprises a rate of return as of the report date.

4. The method of claim 3, wherein each of the current value, the historical price, and the sale price is associated with a date, and wherein:
determining the first performance metric comprises:
determining a change in value between the current value and the historical price; and
dividing the change in value by the length of time between the date of the current value and the date of the historical price, to determine a first change in value per unit time; and
determining the second performance metric comprises:
determining a change in value between the sale price and the historical price; and
dividing the change in value by the length of time between the date of the sale price and the date of the historical price, to determine a second change in value per unit time.

5. The method of claim 4, wherein combining the first and second performance metrics comprises:
determining an average between the first and second changes in value per unit time.

6. The method of claim 4, wherein combining the first and second performance metrics comprises:
determining a weighted average between the first and second changes in value per unit time.

7. The method of claim 3, wherein each of the current value, the historical price, and the sale price is associated with a date, and wherein:
determining the first performance metric for the first security comprises determining a change in value between the current value and the historical price; and
determining the second performance metric for the second security comprises determining a change in value between the sale price and the historical price.

8. The method of claim 7, wherein combining the first and second performance metrics comprises adding together the first and second performance metrics.

9. The method of claim 7, wherein combining the first and second performance metrics comprises:
determining a weighted average between the first and second changes in value per unit time.

10. The method of claim 1, wherein the report date comprises a current date.

11. The method of claim 1, wherein the historical price of each security comprises a purchase price.

12. The method of claim 1, wherein the historical price of each security comprises a value for the security at the time of its acquisition.

13. The method of claim 1, further comprising, prior to determining the first performance metric, obtaining a current value of the security from an online data source.

14. A computer-implemented method for tracking performance of a security holding in a portfolio, the method comprising:
for a first portion of a security holding, the first portion currently held in the portfolio, determining a first performance metric based on a comparison of a current value of the security with a historical price of the security;
for a second portion of the security holding, wherein the second portion was previously held in the portfolio and has been sold, determining a second performance metric based on a comparison of a sale price of the security with a historical price of the security;
combining the first and second performance metrics to obtain an overall performance metric for the security holding; and
outputting the overall performance metric for the security holding.

15. A computer program product for tracking performance of a portfolio, the comprising:
a computer-readable medium; and
computer program code, encoded on the medium, for:
for at least a first security that is currently held in the portfolio, determining a first performance metric based on a comparison of a current value of the security with a historical price of the security;
for at least a second security that was previously held in the portfolio and has been sold, determining a second performance metric based on a comparison of a sale price of the security with a historical price of the security;
combining the first and second performance metrics to obtain an overall performance metric for the portfolio; and
outputting the overall performance metric for the portfolio.

16. The computer program product of claim 15, wherein:
the first performance metric comprises a rate of return for the first security, measured from an acquisition date to a current date;
the second performance metric comprises a rate of return for the second security, measured from an acquisition date to a sale date; and
the overall performance metric for the portfolio comprises a rate of return as of the current date.

17. The computer program product of claim 15, wherein:
the first performance metric comprises a rate of return for the first security, measured from an acquisition date to a report date;
the second performance metric comprises a rate of return for the second security, measured from an acquisition date to a sale date; and
the overall performance metric for the portfolio comprises a rate of return as of the report date.

18. The computer program product of claim 17, wherein each of the current value, the historical price, and the sale price is associated with a date, and wherein:
the computer program code for determining the first performance metric comprises computer program code for:
determining a change in value between the current value and the historical price; and
dividing the change in value by the length of time between the date of the current value and the date of the historical price, to determine a first change in value per unit time; and
the computer program code for determining the second performance metric comprises computer program code for:
determining a change in value between the sale price and the historical price; and
dividing the change in value by the length of time between the date of the sale price and the date of the historical price, to determine a second change in value per unit time.

19. The computer program product of claim 18, wherein the computer program code for combining the first and second performance metrics comprises computer program code for:
determining an average between the first and second changes in value per unit time.

20. The computer program product of claim 18, wherein the computer program code for combining the first and second performance metrics comprises computer program code for:
determining a weighted average between the first and second changes in value per unit time.

21. The computer program product of claim 17, wherein each of the current value, the historical price, and the sale price is associated with a date, and wherein:
the computer program code for determining the first performance metric for the first security comprises computer program code for determining a change in value between the current value and the historical price; and
the computer program code for determining the second performance metric for the second security comprises computer program code for determining a change in value between the sale price and the historical price.

22. The computer program product of claim 21, wherein the computer program code for combining the first and second performance metrics comprises computer program code for adding together the first and second performance metrics.

23. The computer program product of claim 21, wherein the computer program code for combining the first and second performance metrics comprises computer program code for:
determining a weighted average between the first and second changes in value per unit time.

24. The computer program product of claim 15, wherein the report date comprises a current date.

25. The computer program product of claim 15, wherein the historical price of each security comprises a purchase price.

26. The computer program product of claim 15, wherein the historical price of each security comprises a value for the security at the time of its acquisition.

27. The computer program product of claim 15, further comprising computer program code for, prior to determining the first performance metric, obtaining a current value of the security from an online data source.

28. A computer program product for tracking performance of a security holding in a portfolio, comprising:
a computer-readable medium; and
computer program code, encoded on the medium, for:
for a first portion of a security holding, the first portion currently held in the portfolio, determining a first performance metric based on a comparison of a current value of the security with a historical price of the security;
for a second portion of the security holding, wherein the second portion was previously held in the portfolio and has been sold, determining a second performance metric based on a comparison of a sale price of the security with a historical price of the security;
combining the first and second performance metrics to obtain an overall performance metric for the security holding; and
outputting the overall performance metric for the security holding.

29. A system for tracking performance of a portfolio, comprising:
a portfolio analysis module, for:
for at least a first security that is currently held in the portfolio, determining a first performance metric based on a comparison of a current value of the security with a historical price of the security;
for at least a second security that was previously held in the portfolio and has been sold, determining a second performance metric based on a comparison of a sale price of the security with a historical price of the security; and
combining the first and second performance metrics to obtain an overall performance metric for the portfolio;
a report generator, communicatively coupled to the portfolio analysis module, for generating a report based on the determined performance metrics; and
an output device, communicatively coupled to the report generator, for outputting the overall performance metric for the portfolio.

30. The system of claim 29, wherein:
the first performance metric comprises a rate of return for the first security, measured from an acquisition date to a current date;
the second performance metric comprises a rate of return for the second security, measured from an acquisition date to a sale date; and
the overall performance metric for the portfolio comprises a rate of return as of the current date.

31. The system of claim 29, wherein:
the first performance metric comprises a rate of return for the first security, measured from an acquisition date to a report date;
the second performance metric comprises a rate of return for the second security, measured from an acquisition date to a sale date; and
the overall performance metric for the portfolio comprises a rate of return as of the report date.

32. The system of claim 31, wherein each of the current value, the historical price, and the sale price is associated with a date, and wherein:
the portfolio analysis module determines the first performance metric by:
determining a change in value between the current value and the historical price; and
dividing the change in value by the length of time between the date of the current value and the date of the historical price, to determine a first change in value per unit time; and
the portfolio analysis module determines the second performance metric by:
determining a change in value between the sale price and the historical price; and
dividing the change in value by the length of time between the date of the sale price and the date of the historical price, to determine a second change in value per unit time.

33. The system of claim 32, wherein the portfolio analysis module combines the first and second performance metrics by:
determining an average between the first and second changes in value per unit time.

34. The system of claim 32, wherein the portfolio analysis module combines the first and second performance metrics by:
determining a weighted average between the first and second changes in value per unit time.

35. The system of claim 31, wherein each of the current value, the historical price, and the sale price is associated with a date, and wherein:
the portfolio analysis module determines the first performance metric for the first security by determining a change in value between the current value and the historical price; and
the portfolio analysis module determines the second performance metric for the second security by determining a change in value between the sale price and the historical price.

36. The system of claim 35, wherein the portfolio analysis module combines the first and second performance metrics by adding together the first and second performance metrics.

37. The system of claim 35, wherein the portfolio analysis module combines the first and second performance metrics by:
determining a weighted average between the first and second changes in value per unit time.

38. The system of claim 29, wherein the report date comprises a current date.

39. The system of claim 29, wherein the historical price of each security comprises a purchase price.

40. The system of claim 29, wherein the historical price of each security comprises a value for the security at the time of its acquisition.

41. The system of claim 29, further comprising a network communication interface, coupled to the portfolio analysis module, for, prior to determining the first performance metric, obtaining a current value of the security from an online data source.

42. A system for tracking performance of a security holding in a portfolio, comprising:
a portfolio analysis module, for:
for a first portion of a security holding, the first portion currently held in the portfolio, determining a first performance metric based on a comparison of a current value of the security with a historical price of the security;
for a second portion of the security holding, wherein the second portion was previously held in the portfolio and has been sold, determining a second performance metric based on a comparison of a sale price of the security with a historical price of the security; and
combining the first and second performance metrics to obtain an overall performance metric for the security holding; and
a report generator, communicatively coupled to the portfolio analysis module, for generating a report based on the determined performance metrics; and
an output device, communicatively coupled to the report generator, for outputting the overall performance metric for the security holding.
